(19) United States
(12) Patent Application Publication
(10) Pub. No.: US 2016/0026558 A1
(43) Pub. Date: Jan. 28, 2016

(54) METHOD AND SYSTEM FOR MANAGING VIRTUAL SERVICES TO OPTIMIZE OPERATIONAL EFFICIENCY OF SOFTWARE TESTING

(71) Applicant: Wipro Limited, Bangalore (IN)

(72) Inventors: Krishnaraj Padur Krishnan, Bangalore (IN); Hemantha Kumar Choudam, Bangalore (IN)

(21) Appl. No.: 14/483,713

(22) Filed: Sep. 11, 2014

(30) Foreign Application Priority Data
Jul. 26, 2014 (IN) 3655/CHE/2014

(51) Int. Cl. G06F 11/36; G06F 9/455

(52) U.S. Cl. CPC G06F 11/3668; G06F 9/455

(57) ABSTRACT

Embodiments of the present disclosure disclose a method for managing virtual services to optimize operational efficiency of software testing. The method comprises one or more steps performed by a virtual service management system. First step of the method comprises identifying one or more integration points of a business process. The one or more integration points define dependability of the business process on at least one actual service. Second step of the method comprises determining association of the one or more integration points with the at least one actual service. Third step of the method comprises receiving a virtual service for the corresponding actual service based on details of the one or more integration points. Fourth step of the method comprises mapping the virtual service to one or more other business processes.

This application claims the benefit of Indian Patent Application Serial No. 3655/CHE/2014 filed Jul. 26, 2014, which is hereby incorporated by reference in its entirety.

### FIELD

The present subject matter is related, in general to virtual services and more particularly, but not exclusively to a method and a virtual service management system for managing virtual services to optimize operational efficiency of software testing.

### BACKGROUND

Generally, in Information Technology (IT) field, most businesses rely on IT infrastructures for managing day to day operations. For example, a user such as a system administrator or operator may manage the complex IT infrastructure by installing software, testing software, and updating software etc. Software testing can require a significant amount of development time, computer and human resources, and effort. For example, software testing may involve numerous tasks ranging from ensuring correct coding syntax, and checking the output of a software program. In addition, during software testing, there is a dependency on one or more actual services with reference to a business process. The one or more actual services provided by third parties are accessed for software testing. Accessing the one or more actual services incurs high cost, and high load time. Sometimes, the one or more actual services are not available. For example, the one or more actual services may be down for maintenance or enhancement or in use by other third parties etc. This results to inaccessibility of the one or more actual services for software testing. Further, using the actual services for testing software impacts the Software Development Life Cycle (SDLC) and Software Testing Life Cycle (STLC) timelines.

To address the inaccessibility and increasing cost challenges, businesses adopts virtualization technologies required for software testing. The virtualization technologies involve service virtualization which virtualizes or simulates the dependency constraints, i.e. one or more actual services into virtual services. The virtual services help overcome bottlenecks in using dependency constraints (actual services) during testing. Also, the virtual services reduce the cycle times for software development and testing and the cost involved in using the one or more actual services.

In an organization, managing the growing pool of the virtual service assets along with multiple versions representing different functionality is a difficult task. Usually, in an organization, there exists ‘n’ number of actual services. When an actual service is created or updated, a virtual service for the corresponding actual service is generated. However, tracking an update of each of the actual service is a difficult challenge. Further, keeping a track of virtual service for the corresponding actual service is also a problem in the existing system. When multiple versions of the same virtual service co-exist, traceability becomes a challenge. Therefore, re-use of an appropriate virtual service for testing different business processes is difficult. Sometimes the same virtual service is created multiple times when the virtual service is not traceable during the software testing. Therefore, there exists a problem to manage different virtual services along with their versions.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Disclosed herein is a method for managing virtual services to optimize operational efficiency of software testing. The method comprises one or more steps performed by a virtual service management system. First step of the method comprises identifying one or more integration points of a business process. The one or more integration points define dependability of the business process on at least one actual service. Second step of the method comprises determining association of the one or more integration points with the at least one actual service. Third step of the method comprises receiving a virtual service for the corresponding actual service based on details of the one or more integration points. Fourth step of the method comprises mapping the virtual service to one or more other business processes.

In an aspect of the present disclosure, a virtual service management system for managing virtual services to optimize operational efficiency of software testing is disclosed. The virtual service management system comprises a processor and a memory communicatively coupled to the processor. The memory stores processor-executable instructions, which on execution, cause the processor to identify one or more integration points of a business process. The one or more integration points define dependability of the business process on at least one actual service. The processor is further configured to determine association of the one or more integration points with the at least one actual service. The processor is further configured to receive a virtual service for the corresponding actual service based on details of the one or more integration points. The processor is further configured to map the virtual service to one or more other business processes.

In another aspect of the present disclosure, a non-transitory computer readable medium for managing virtual services to optimize operational efficiency of software testing is disclosed. The non-transitory computer readable medium includes instructions stored thereon that when processed by a processor causes a virtual management system to perform one or more acts. Firstly, identifying one or more integration points of a business process is performed. The one or more integration points define dependability of the business process on at least one actual service. Then, determining association of the one or more integration points with the at least one actual service is performed. Next, receiving a virtual service for the corresponding actual service based on details of the one or more integration points is performed. Lastly, mapping the virtual service to one or more other business process is performed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a block diagram of a virtual service management system for managing virtual services to optimize operational efficiency of software testing in accordance with some embodiments of the present disclosure;

FIG. 2 illustrates a block diagram of an update module for updating version of virtual service in accordance with some embodiments of the present disclosure;

FIG. 3 illustrates a flowchart showing method for managing virtual services to optimize operational efficiency of software testing in accordance with some embodiments of the present disclosure; and

FIG. 4 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises... a” does not, without more constraints, preclude the existence of other elements or additional elements in the system or apparatus.

Embodiments of the present disclosure are related to management of virtual services to optimize operational efficiency of software testing of a business process. In the business process, integration points and association of the integration points with actual services are identified. Using the details of the integration points, the actual services for testing the business process are virtualized into virtual service by a third party system. The created virtual service is received from the third party system and is mapped to the business process. The virtual service is mapped to other business processes as well which requires the same virtual service for testing the other business processes. In regular intervals, a Web Services Description Language (WSDL) for an original actual service is retrieved. Then, the latest WSDL file is compared with a parsed XML file of virtual service which is already stored for testing process. When a change is detected, then a virtual service corresponding to a new version of the original actual service is generated. Then, the new version of the virtual service is updated and mapped to the one or more process paths and business processes for testing.

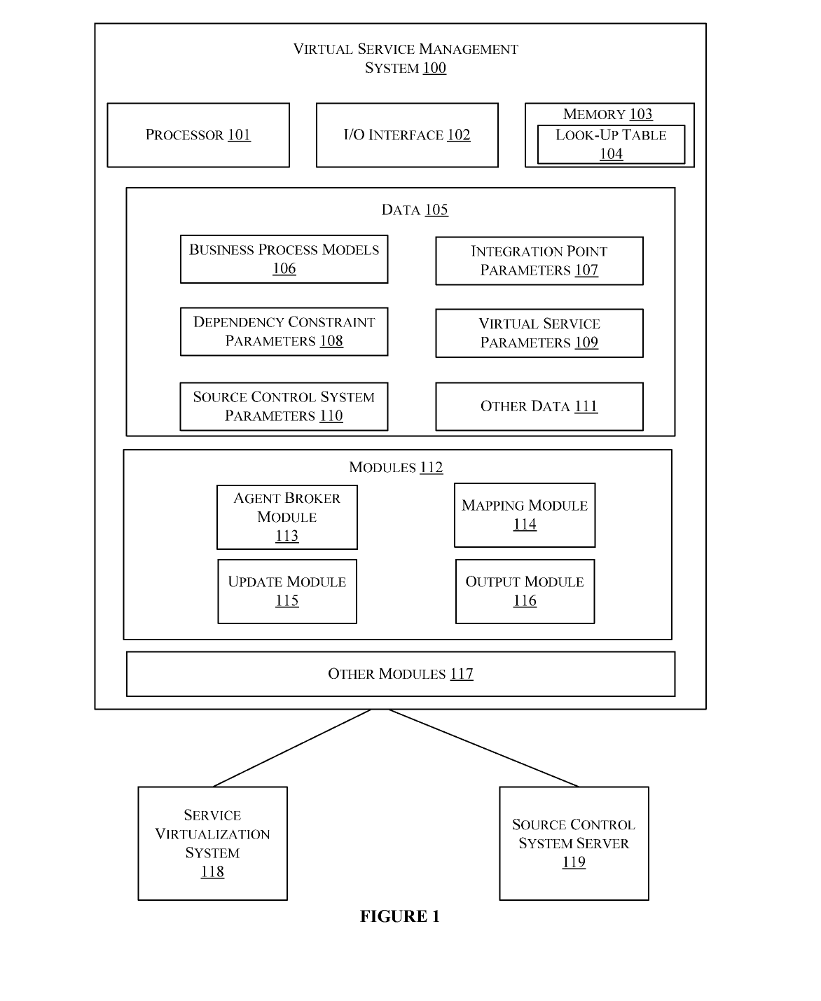

FIG. 1 illustrates a block diagram of the virtual service management system 100 for managing virtual service to optimize operational efficiency of software testing in accordance with some embodiments of the present disclosure.

The virtual service management system 100 may be implemented in a variety of computing systems, such as a laptop computer, a desktop computer, a notebook, a workstation, a mainframe computer, a server, a network server, and the like. The virtual service management system 100 optimizes the operational efficiency of software testing of the business process. In an embodiment, the virtual service management system 100 is configured to receive the business process from the one or more client machines (not shown in FIG. 1). The virtual service management system 100 is communicatively connected to the one or more client machines through a network (not shown in FIG. 1). Examples of the one or more client machines include, but are not limited to, a desktop computer, a portable computer, a mobile phone, a handheld device, a workstation. In one implementation, the virtual service management system 100 acts as client machine also. Therefore, the business process is directly received from the user in the virtual service management system 100. In an embodiment, a business process refers to a program module which includes, but is not limited to, test cases, tasks, executable instructions, program codes, implementation steps, functions and structured activities. For example, a software tester may run software test cases to test functioning of a desired product.

Further, the virtual service management system 100 is communicatively connected to a service virtualization system 118 and a source control system server 119 through a network.

In one implementation, the virtual service management system 100 includes a central processing unit (“CPU” or “processor”) 101, an input/output (I/O) interface 102 and a memory 103. The processor 101 may comprise at least one data processor for executing program components and for executing user- or system-generated business process. The I/O interface 102 is coupled with the processor 101 through which the data like business processes are received from the one or more client machines. The memory 103 is communicatively coupled to the processor 101. The memory 103 stores processor-executable instructions to optimize operational efficiency of the software testing. In one implementation, the memory 103 comprises a look-up table 104. In an embodiment, the look-up table 104 stores information which includes, but is not limited to, details of one or more integration points, versions of the virtual service corresponding to versions of the one or more actual services, criticality score of one or more process paths of the business process, storage location information, port information and Internet Protocol (IP) information.

In an embodiment, the virtual service management system 100 receives data 105 relating to the business process from the one or more client machines. In one example, the data 105 received from the one or more client machines may be stored within the memory 103. In one implementation, the data 105 may include, for example, business process models 106, integration point parameters 107, dependency constraint parameters 108, virtual service parameters 109, source control system parameters 110, and other data 111.

In an embodiment, the business process models 106 are generated using notations which include, but are not limited to, Business Process Model and Notation (BPMN) and Unified Modeling Language (UML). As an example, the business process is modeled in a form of extensible mark-up language (XML). In an embodiment, the one or more process paths of the business process are identified. The one or more process paths serve as navigation aid in the business process. More particularly, the one or more process paths are paths through which the testing of the business process is implemented. For example, consider a testing environment of a business process which comprises a program code of 100 statements. The 100 statements are termed as process paths which may be compiled and executed for software testing. After identifying the one or more process paths of the business process, a criticality score is evaluated for each of the one or more process paths. The criticality score defines the criticality of the one or more process paths. For example, considering the statement 56 is an important code line among 100 code lines. The statement 56 is a significant code line and is given critical score of ‘2’ based on its criticality of testing.

The integration point parameters 107 are received as one of the data 105 which act as interface/medium for communication of the business process with one or more actual services. In an embodiment, the integration point parameters 107 are identified in the one or more process paths of the business process. In one implementation, the integration point parameters 107 comprise one or more integration points and details like Web Services Description Language (WSDL) and operation name etc. The one or more integration points are identified in the business process received from the one or more client machines. The one or more integration points define dependence of the business process on at least one actual service. The one or more actual services include, but are not limited to, applications, resources, test cases, tasks, executable instructions, program codes, implementation steps, and structured activities. Usually, for software testing, one or more actual services are accessed. In one example, the business processes and the at least one actual service are the applications. In an embodiment, the one or more integration points are interface/interfaces through which one application may interact with one or more other applications. An example of the one or more integration points is illustrated herein. For example, consider a business process in which a ‘payroll’ application is run for setting the payroll for each of employee in a company. The business process requires setting the payroll two days before salary is credited. The credit of the payroll depends on the attendance of each employee. In particular, the ‘payroll’ application depends on the ‘attendance application’. Therefore, there exists an interaction of the ‘payroll’ application with the ‘attendance application’ for setting the payroll. Now, the point “two days before salary is credited” is an integration point at which the ‘payroll’ application interacts with the ‘attendance application’ for setting the payroll for the employee.

In an embodiment, the details of the one or more integration points are identified as dependency constraints 108 for testing the business process. For example, details like which process path contains the dependency constraints 108 is identified for testing the business process. That is, the process path in which the one or more integration points are leading to the at least one actual service is identified.

The virtual service parameters 109 include details of the virtual services on which the business process is dependent for testing. Typically in an embodiment, the virtual services are generated by the service virtualization system 118. The service virtualization system 118 generates virtual services for the corresponding one or more actual services. As an example, in case of web service, a WSDL file of an actual service is used for creating a virtual service. The service virtualization system 118 simulates or virtualizes the one or more actual services to create virtual services. Thus, the virtual services are used during testing instead of using the one or more actual services. Additionally, the service virtualization system 118 helps to increase utilization and sharing of the one or more actual services between one or more business processes. In an embodiment, the generated virtual services are stored in the source control system server 119. In an embodiment, the source control system server 119 is a server, for example, Apache SubVersion named SVN which stores the virtual services generated by the service virtualization system 118. In an embodiment, the source control system server 119 stores versions of the virtual services generated by the service virtualization system 118. The source control system server 119 includes Uniform Resource Locator (URL) of the virtual services for reference.

The details of the virtual services contained in the virtual service parameters 109 include, but are not limited to, port information, host server information, and Uniform Resource Locator (URL) of the virtual services. The port information includes the port address of the source control system server 119 in which the virtual services are stored. For example, port address ‘58881P’ of the source control system server 119 stores the virtual service ‘vabc’ for the corresponding actual service ‘abc’. The host server information provides the details of the host server in which the virtual services are stored.

The source control system parameters 110 include URL to locate the virtual services in the source control system server 119. Particularly, the URL provides link to various versions of the virtual service which are stored in the source control system server 119.

In one embodiment, the data 105 may be stored in the memory 103 in the form of various data structures. Additionally, the aforementioned data 105 may be organized using data models, such as relational or hierarchical data models. The other data 105 may be used to store data, including temporary data and temporary files, generated by the modules 112 for performing the various functions of the virtual service management system 100. In an embodiment, the data 105 received from the one or more client machines are processed by modules 112 of the virtual service management system 100. The modules 112 may be stored within the memory 103.

In one implementation, the modules 112 may include, for example, an agent broker module 113, a mapping module 114, an update module 115 and an output module 116. The virtual service management system 100 may also comprise other modules 117 to perform various miscellaneous functionalities of the virtual service management system 100. It will be appreciated that such aforementioned modules may be represented as a single module or a combination of different modules.

The agent broker module 113 identifies the one or more integration points. For example, consider a business process requires setting salary for an employee two days before the credit of the salary based on the attendance of the employee. Now, the point ‘two days before’ is considered as integration point to allow interaction of the ‘payroll’ application with the ‘attendance application’. Next, the agent broker module 113 determines association of the one or more integration points with at least one actual service i.e. ‘attendance application’. Let the ‘attendance application’ be represented as ‘abc’ in the illustrative example. For example, association of the business process with the actual service ‘abc’ for testing is determined. In an embodiment, the association of the business process with the actual service ‘abc’ is determined through the one or more process paths. Considering the process paths for the business process be ‘DEF’ through which the business process is associated to the actual service ‘abc’. Based on the details of the one or more integration points identified by the agent broker 113, the service virtualization system 118 generates virtual service for the corresponding actual service ‘abc’. For example, for testing the business process, an association to actual service “abc” through the one or more integration points is identified. Then, based on the details of one or more integration points of the business process, the service virtualization system 118 generates a virtual service ‘vabc’ of corresponding actual service ‘abc’. The virtual service ‘vabc’ along with version are stored in the source control system server 119. The stored virtual service ‘vabc’ corresponding to the actual service ‘abc’ is referred by the virtual service management system 100 using the reference link.

The virtual service management system 100 receives the link i.e. URL of the virtual service for the corresponding actual service from the source control system server 119. In an embodiment, the URL of the virtual service received is stored in the look-up table 104 of the memory 103. The virtual service is linked to the corresponding actual service using a unique Uniform Resource Identifier (URI) in the look-up table 104. For example, the virtual service of the actual service “vabc” is linked to the actual service “abc” by URI “http:” or “ftp:” or “file:’ in the look-up table 104. In an embodiment, each of the actual service is associated with a unique identifier (ID). For example, the URI for linking the virtual service with the actual service “abc” is “file://abc.co.in/abc.text”. In an embodiment, reference to storage location where the virtual service is stored in the service virtualization system 118 is stored in the look-up table 104 along with version of the virtual service, Internet Protocol (IP) information and port information. The following Table 1 shows an exemplary look-up table 104 storing the URL of the virtual service for the corresponding actual service, reference to the storage location of the virtual service, version of the virtual service, IP information of the virtual service and port information of the virtual service.

TABLE 1

| | URI of the | | | | | | |
|---|---|---|---|---|---|---|---|
| | virtual | | | | | | |
| | service | | | | Storage | | |
| | linked | | | | Location | | |
| | with the | Version of | Version of | URL of | of the | | |
| Process | actual | the Actual | the Virtual | the Virtual | Virtual | IP | Port |
| path(s) | service | Service | Service | Service | Service | Information | Information |
| DEF | file://abc.co.in/abc.text | 21 | 21 | http://abc.in/abc.text | LOC1111 | 131.168.1.1 | 5881P |

The above Table 1 shows the look-up table 104. Considering, one or more integration points of a business process through which an association to the actual service “abc” is identified for testing. The process path of the business process is ‘DEF’ through which the association of the business process with the actual service ‘abc’ is determined. The virtual service for the actual service is “vabc”. The virtual service “vabc” is linked to the corresponding actual service through URI “file://abc.co.in/abc.text”. Assuming, the unique ID of the actual service is “IDXXDBC” and the version of the actual service is “21” (i.e. 21st version of the actual service is referred). Assuming, the URL of the virtual service ‘vabc’ is (“http://abc.in/abc/text’) which is stored in the look-up table 104 as shown in Table 1. The storage location is the location in the source control system server 119 where the virtual service is stored. For example, assuming, the virtual service is stored in “LOC1111” location of the source control system server 119. Therefore, the storage location information “LOC1111” is stored in the look-up table 104 as shown in the table 1. The IP information of the source control system server 119 where the virtual service is stored is “131.168.1.1”. And the port information where the virtual service is stored in the source control system server 119 is “5881P”. The version of the virtual service is corresponding to the version of actual service “21” i.e. 21st version of the virtual service “vabc” is stored in the look-up table 104.

After the details of the virtual service are stored in the look-up table 104, the virtual service is mapped to the business process for executing the business process by the mapping module 114. For example, virtual service “vabc” is mapped to the business process and the one or more process paths for testing of the business process. Assuming, the process path through which the business process A-BP1 is associated to the actual service ‘abc’ is ‘DEF’. The process path through which the business process K-BP2 is associated to the actual service ‘abc’ is ‘GIT’ and the process path through which the business process P-BP3 is associated to the actual service ‘abc’ is ‘JKLM’. In an embodiment, the virtual service is mapped to one or more other business processes requiring the virtual service for their execution. For example, considering 3 business processes A, K, and P requiring the virtual service “vabc” of 21st version based on the one or more integration points. Therefore, the 21st version of the virtual service “vabc” is mapped to the business processes A, K and P. Table 2 shows an exemplary look-up table 104 where the one or more business processes BP1, BP2 and BP3 mapped with the virtual service “vabc”.

TABLE 2

| | | Versions of the | Version of the |
|---|---|---|---|
| | | Actual Service | Virtual Service |
| Business Processes | Process Paths | ‘abc’ | ‘vabc’ |
| A-BP1 | DEF | abc21 | vabc21 |
| K-BP2 | GIT | abc21 | vabc21 |
| P-BP3 | JKLM | abc21 | vabc21 |

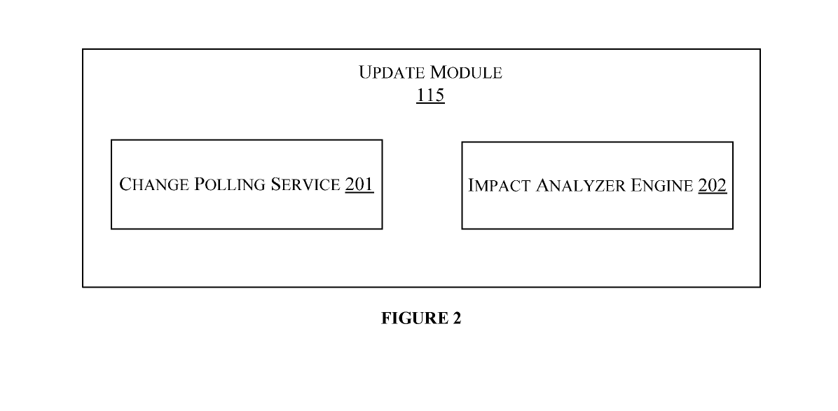

In an embodiment, a change in a version of the actual service is identified. Particularly, a change in version of the virtual service is identified by identifying a change in a version of the corresponding actual service. In an embodiment, the update module 115 comprises a change polling service 201 and an impact analyzer engine 202 as shown in FIG. 2. The change polling service 201 and the impact analyzer engine 202 are configured to identify a change in version of the actual service and update the new version in the look-up table 104. The change polling service 201 is configured to poll the actual service corresponding to WSDL file (of the virtual service) referred in the look-up table 104 for identifying changes at predefined time intervals. Then, the change polling service 301 connects to the actual service through Application Programming Interface (API) and retrieves the corresponding WSDL file for the actual service. The retrieved WSDL file is provided to the impact analyzer engine 202. The impact analyzer engine 202 parses the XML file of various virtual services stored therein. Then, the impact analyzer engine 202 compares the parsed virtual service XML with the latest WSDL file of the actual service. The impact analyzer engine 202 updates the version of the virtual service in the look-up table 104. When a change is detected, then a virtual service corresponding to a new version of the actual service is generated. Then, the new version of the virtual service is updated in the look-up table 104. Thus, the changed version of the virtual service is mapped to the business processes and the one or more process paths to be accessed for testing.

For example, a new version of the actual service is updated. That is, a version of actual service is changed i.e. from 21st to 22nd version. Then, the update module 115 updates the version number as 22nd in the look-up table 104. Table 3 shows an exemplary look-up table 104 storing updated version of the actual service.

TABLE 3

| | | | | | New Version of |
|---|---|---|---|---|---|
| | | | | | the Virtual |
| | | Old | New | | Service |
| | | Version | Version | Old Version | corresponding to |
| | | of the | of the | of the | the new version |
| Business | Process | Actual | Actual | Virtual | of the Actual |
| Processes | Path | Service | Service | Service | Service |
| A-BP1 | DEF | abc21 | abc22 | vabc21 | vabc22 |
| K-BP2 | GIT | abc21 | abc22 | vabc21 | vabc22 |
| P-BP3 | JKLM | abc21 | abc22 | vabc21 | vabc22 |

As shown in above Table 3, the look-up table 104 stores both old version and updated version of both the actual and virtual service. In an embodiment, the mapping module 114 maps the updated version of the virtual service to the business process, the one or more process paths and the one or more other business processes as well.

In an embodiment, the output module 116 of the virtual service management system 100 provides a report on the details of the one or more integration points and the virtual service based on at least one of the criticality score, the business process and the one or more other business processes. The output module 116 provides a drill down view of the one or more integration points and the virtual services. In an embodiment, a view of the report is provided in a form which includes, but is not limited to, top down view and bottom up view. As an example, the top down view may be provided for business analysts starting from the business process, then process paths and then integration points and so on. The bottom up view may be provided for integration test engineer that starts with the integration points. The report is provided, for example as file output, to the one or more client machines.

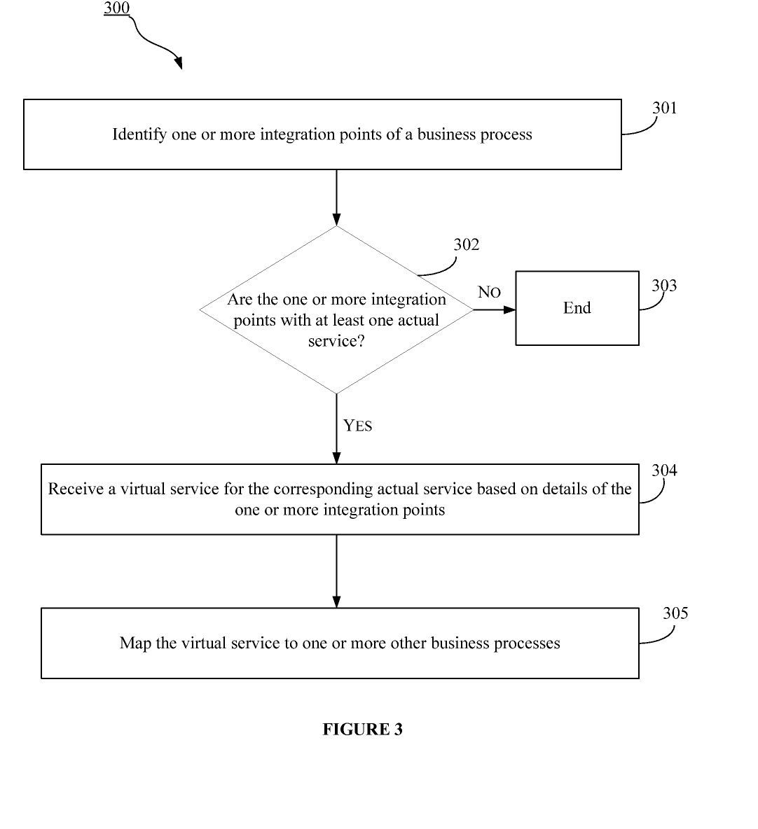

FIG. 3 illustrates a flowchart of method 300 for managing the virtual services to optimize operational efficiency of the software testing in accordance with an embodiment of the present disclosure.

As illustrated in FIG. 3, the method 300 comprises one or more blocks for managing the virtual services to optimize operational efficiency performed by the virtual service management system 100. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method 300. Additionally, individual blocks may be deleted from the method 300 without departing from the spirit and scope of the subject matter described herein. Furthermore, the method 300 can be implemented in any suitable hardware, software, firmware, or combination thereof.

At block 301, identifying one or more integration points of a business process received from the one or more client machines. In an embodiment, the one or more integration points of the business process are identified. The one or more integration points define dependence of the business process on at least one actual service. In one implementation, one or more process paths of the business process are identified. After identifying the one or more process paths, a criticality score to each of the one or more process paths of the business process is provided.

At block 302, determining association of the one or more integration points with at least one actual service. In an embodiment, the virtual service management system 100 determines whether the one or more integration points are associated to at least one actual service. If the one or more integration points of the business process are associated to at least one actual service, then the process proceeds to block 304 via “YES”. In an embodiment, the virtual service for the corresponding actual service is generated by the service virtualization system 106 based on the details of the one or more integration points. In an embodiment, the generated virtual service is stored in the source control system server 119 which provides URL of the virtual service to the virtual service management system 100. At block 304, a virtual service for the corresponding actual service is received based on details of the one or more integration points.

If the one or more integration points of the business process are not associated to the one at least one actual service, then the process proceeds to block 303 via “NO” where the process ends.

At block 305, the virtual service is mapped to the business process and one or more other business processes. In an embodiment, the method of mapping the virtual service for testing is explained herein. The agent broker module 113 marks the one or more integration points of the business process as candidates for generating virtual services. The details of the one or more integration points are then used by the service virtualization system 118 for generating the virtual service. Once the virtual service is generated, a reference to the storage location where the virtual service is residing at the source control system server 119 is mapped to the business process. In addition, IP and port details along with the version number of the virtual service are mapped.

In an embodiment, the process 300 performs updating a version of the virtual service in the look-up table 104 upon identifying a change in a version of the corresponding actual service. Then, the updated version of the virtual service is mapped to the business process, the one or more process paths and one or more other business processes as well.

In an embodiment, the process 300 further performs providing a report on the details of the one or more integration points and the virtual service based on at least one of the criticality score, the business process and the one or more other business processes.

### Computer System

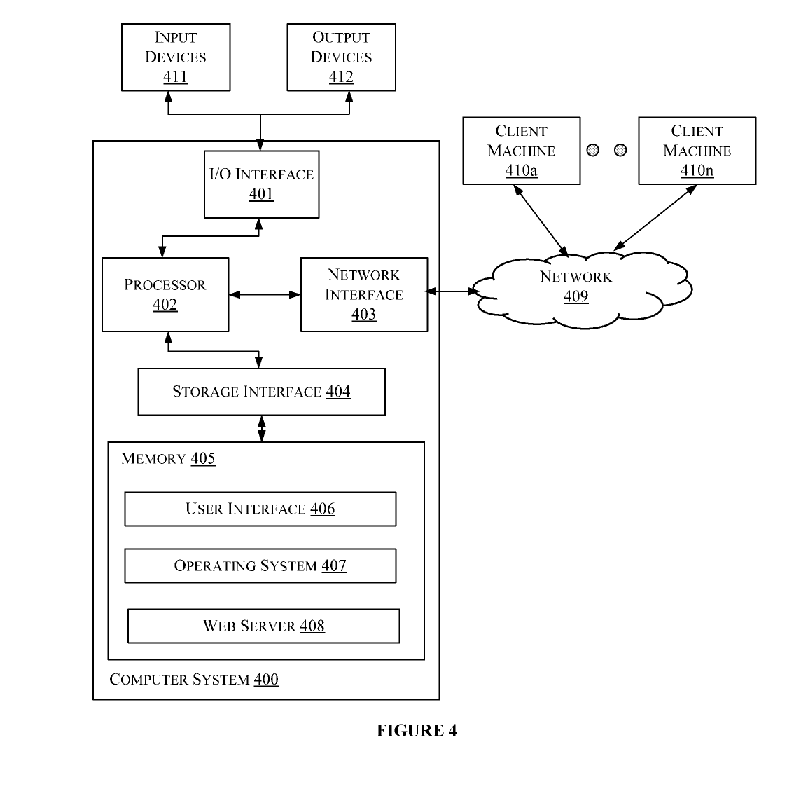

FIG. 4 illustrates a block diagram of an exemplary computer system 400 for implementing embodiments consistent with the present disclosure. In an embodiment, the computer system 400 is used to implement the virtual service management system 100. The virtual services are managed by the computer system 400 to optimize the operational efficiency of software testing. The computer system 400 may comprise a central processing unit (“CPU” or “processor”) 402. The processor 402 may comprise at least one data processor for executing program components for executing user- or system-generated business processes. A user may include a person, a person using a device such as such as those included in this disclosure, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 401, the computer system 400 may communicate with one or more I/O devices (411 and 412). For example, the input device 411 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. The output device 412 may be a printer, fax machine, video display (e.g., cathode ray tube (CRT), liquid crystal display (LCD), light-emitting diode (LED), plasma, or the like), audio speaker, etc.

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 409 may include, without limitation, a direct interconnection, local area network (LAN), wide area network (WAN), wireless network (e.g., using Wireless Application Protocol), the Internet, etc. Using the network interface 403 and the communication network 409, the computer system 400 may communicate with one or more client machines 410 (a,..,n). The one or more client machines 410 (a,...,n) may include, without limitation, personal computer(s), server(s), fax machines, printers, scanners, various mobile devices such as cellular telephones, smartphones, tablet computers, eBook readers, laptop computers, notebooks, gaming consoles, or the like. In an embodiment, a business process is received from the one or more client machines 410 (a, . . . ,n) which may be used by various stakeholders, Information Technology (IT) administrators, business analyst, software tester, software developer or end users of an organization.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 405 may store a collection of program or database components, including, without limitation, user interface application 406, an operating system 407, web server 408 etc. In some embodiments, computer system 400 may store user/application data 406, such as the data, variables, records, etc. as described in this disclosure. Such databases may be implemented as fault-tolerant, relational, scalable, secure databases such as Oracle or Sybase.

The operating system 407 may facilitate resource management and operation of the computer system 400. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 400, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 400 may implement a web browser 408 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObj ects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

Advantages of the embodiment of the present disclosure are illustrated herein.

Embodiment of the present disclosure manages the virtual services for one or more business processes.

Embodiment of the present disclosure resolves traceability of virtual services assets along with their appropriate version for testing.

Embodiment of the present disclosure manages the growing pool of the virtual services in the testing environment.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor and a processor capable of processing and executing the queries. A non-transitory computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media comprise all computer-readable media except for a transitory. The code implementing the described operations may further be implemented in hardware logic (e.g., an integrated circuit chip, Programmable Gate Array (PGA), Application Specific Integrated Circuit (ASIC), etc.).

Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” comprises non-transitory computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the invention, and that the article of manufacture may comprise suitable information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required.

On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 3 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for managing virtual services to optimize operational efficiency of software testing, comprising:
identifying, by a virtual service management computing device, one or more integration points of a business process, wherein the one or more integration points define dependability of the business process on at least one actual service;
determining, by the virtual service management computing device, association of the one or more integration points with the at least one actual service;
receiving, by the virtual service management computing device, a virtual service for the corresponding actual service based on details of the one or more integration points; and
mapping, by the virtual service management computing device, the virtual service to one or more other business processes.

2. The method as set forth in claim 1, further comprising:
updating, by the virtual service management computing device, a version of the virtual service upon identifying a change in a version of the corresponding actual service.

3. The method as set forth in claim 1, further comprising:
identifying, by the virtual service management computing device, one or more process paths of the business process; and
providing, by the virtual service management computing device, a criticality score to each of the one or more process paths of the business process.

4. The method as set forth in claim 3, further comprising:
providing, by the virtual service management computing device, a report on the details of the one or more integration points and the virtual service based on at least one of the criticality score, the business process and the one or more other business processes.

5. The method as set forth in claim 3, further comprising:
storing, by the virtual service management computing device, the updated version of the virtual service with the corresponding updated version of the actual service, the details of the one or more integration points and the one or more process paths of the business process in a look-up table.

6. The method as set forth in claim 5 wherein the virtual service is linked to the corresponding actual service using a unique uniform resource identifier (URI) in the look-up table.

7. The method as set forth in claim 6 wherein linking the virtual service with the corresponding actual service further comprises:
linking, by the virtual service management computing device, the version of the virtual service and reference to storage location of the virtual service with Internet Protocol (IP) information and port information of the corresponding version of the actual service in the look-up table.

8. The method as set forth in claim 1, further comprising:
associating, by the virtual service management computing device, the at least one actual service with a unique identifier (ID).

9. A virtual service management computing device comprising:
a processor coupled to a memory and configured to execute programmed instructions stored in the memory, comprising:
identifying one or more integration points of a business process, wherein the one or more integration points define dependability of the business process on at least one actual service;
determining association of the one or more integration points with the at least one actual service;
receiving a virtual service for the corresponding actual service based on details of the one or more integration points; and
mapping the virtual service to one or more other business processes.

10. The device as set forth in claim 9 wherein the processor is further configured to execute further instructions stored in the memory further comprising:
updating a version of the virtual service upon identifying a change in a version of the corresponding actual service.

11. The device as set forth in claim 9 wherein the processor is further configured to execute further instructions stored in the memory further comprising:
identifying one or more process paths of the business process; and
providing a criticality score to each of the one or more process paths of the business process.

12. The device as set forth in claim 11 wherein the processor is further configured to execute further instructions stored in the memory further comprising:
providing a report on the details of the one or more integration points and the virtual service based on at least one of the criticality score, the business process and the one or more other business processes.

13. The device as set forth in claim 11 wherein the processor is further configured to execute further instructions stored in the memory further comprising:
storing the updated version of the virtual service with the corresponding updated version of the actual service, the details of the one or more integration points and the one or more process paths of the business process in a look-up table.

14. The device as set forth in claim 13 wherein the virtual service is linked to the corresponding actual service using a unique uniform resource identifier (URI) in the look-up table.

15. The device as set forth in claim 9 wherein the processor is further configured to execute further instructions stored in the memory further comprising:
linking the version of the virtual service and reference to storage location of the virtual service with Internet Protocol (IP) information and port information of the corresponding version of the actual service in the look-up table.

16. The device as set forth in claim 9 wherein the processor is further configured to execute further instructions stored in the memory further comprising:
associating the at least one actual service with a unique identifier (ID).

17. A non-transitory computer readable medium having stored thereon instructions for managing virtual services to optimize operational efficiency of software testing comprising machine executable code which when executed by a processor, causes the processor to perform steps comprising:
identifying one or more integration points of a business process, wherein the one or more integration points define dependability of the business process on at least one actual service;
determining association of the one or more integration points with the at least one actual service;
receiving a virtual service for the corresponding actual service based on details of the one or more integration points; and
mapping the virtual service to one or more other business processes.

18. The medium as set forth in claim 17 wherein the medium further comprises machine executable code which, when executed by the processor, causes the processor to perform steps further comprising:
updating a version of the virtual service upon identifying a change in a version of the corresponding actual service.

19. The medium as set forth in claim 17 wherein the medium further comprises machine executable code which, when executed by the processor, causes the processor to perform steps further comprising:
identifying one or more process paths of the business process; and
providing a criticality score to each of the one or more process paths of the business process.

20. The medium as set forth in claim 20 wherein the medium further comprises machine executable code which, when executed by the processor, causes the processor to perform steps further comprising:
providing a report on the details of the one or more integration points and the virtual service based on at least one of the criticality score, the business process and the one or more other business processes.

21. The medium as set forth in claim 20 wherein the medium further comprises machine executable code which, when executed by the processor, causes the processor to perform steps further comprising:
storing the updated version of the virtual service with the corresponding updated version of the actual service, the details of the one or more integration points and the one or more process paths of the business process in a look-up table.

22. The medium as set forth in claim 21 wherein the virtual service is linked to the corresponding actual service using a unique uniform resource identifier (URI) in the look-up table.

23. The medium as set forth in claim 17 wherein the medium further comprises machine executable code which, when executed by the processor, causes the processor to perform steps further comprising:
linking the version of the virtual service and reference to storage location of the virtual service with Internet Protocol (IP) information and port information of the corresponding version of the actual service in the look-up table.

24. The medium as set forth in claim 17 wherein the medium further comprises machine executable code which, when executed by the processor, causes the processor to perform steps further comprising:
associating the at least one actual service with a unique identifier (ID).
